(19) United States
(12) Patent Application Publication
(10) Pub. No.: US 2021/0046915 A1
(43) Pub. Date: Feb. 18, 2021

(54) TWO STAGE BRAKE ACTUATION SYSTEM AND METHOD

(71) Applicant: HALDEX BRAKE PRODUCTS CORPORATION, KANSAS CITY, MO (US)

(72) Inventors: RICHARD ILLINGWORTH, SMITHVILLE, MO (US); WYATT KOVICH, KANSAS CITY, MO (US); MICHAEL JENKINS, KANSAS CITY, MO (US)

(21) Appl. No.: 16/978,802

(22) PCT Filed: Mar. 13, 2019
(86) PCT No.: PCT/US2019/022025

§ 371 Date: Sep. 8, 2020

Related U.S. Application Data
(60) Provisional application No. 62/643,223, filed on Mar. 15, 2018.

(51) Int. Cl. B60T 13/74; B60T 13/58; F16D 65/16; B60T 13/66; B60T 13/24

(52) U.S. Cl. CPC B60T 13/746; B60T 13/588; F16D 65/16; F16D 2121/04; B60T 13/24; B60T 2270/10; B60T 13/662

(57) ABSTRACT

A two stage brake actuation system including a push rod, a first actuator coupled to the push rod, and a second actuator. The first actuator may apply a first force to the push rod to move it between a brake clearance position and a brake adjacent position. The second actuator may apply a second force to the push rod to move it between the brake adjacent position and a brake applied position. The first actuator may be a large displacement, low force actuator, and the second actuator may be a small displacement, high force actuator. A method for braking a vehicle by applying a first force to a push rod to move it a first distance from a brake clearance to a brake adjacent position, and applying a second force to the push rod to move it a second distance from the brake adjacent to a brake applied position.

### CROSS-REFERENCE TO RELATED APPLICATIONS

This application is based on and claims priority to U.S. Provisional Application Ser. No. 62/643,223, filed on Mar. 15, 2018, which is incorporated herein by reference in its entirety.

### BACKGROUND OF THE INVENTION

### 1. Field of the Invention

The present application relates generally to braking systems and, in particular, to brake actuation systems and methods.

### 2. Description of Related Art

A conventional braking system for a commercial vehicle includes a number of brake actuators that are each operable to apply a force to a disc brake or drum brake at a wheel end of the vehicle. A conventional brake actuator operates in a single stage as it applies a constant force to the brake throughout the entire range of travel of the actuator. For example, a conventional pneumatic brake actuator includes a piston that is joined to a push rod. To actuate a brake with the actuator, a valve opens to direct pressurized air to one side of the piston. The pressurized air exerts a force on the piston that moves the push rod toward the brake. The push rod moves an actuation mechanism of the brake to move the brake pads/shoes toward the brake disc/drum. Before the brake is actuated, the brake pads/shoes are typically set at a desired clearance distance from the brake disc/drum that allows the wheel to rotate and allows actuation of the brake within a desired time period. When the brake is actuated, the pressurized air exerts a constant force on the brake actuator piston throughout the entire range of movement of the brake pads/shoes from their clearance position to the brake disc/drum engaged position. Further, if the brakes need to be applied quickly to, for example, avoid a hazard on the road, the brake pads/shoes must move the entire distance from their clearance position to the brake disc/drum engaged position before the vehicle begins to slow.

### BRIEF SUMMARY OF THE INVENTION

A method for braking a vehicle in accordance with one aspect of the invention described herein includes applying a first force to a push rod to move the push rod a first distance from a brake clearance position to a brake adjacent position, and applying a second force to the push rod to move the push rod a second distance from the brake adjacent position to a brake applied position. The first force may be less than the second force, and the first distance may be greater than the second distance. The method may be carried out by any of the pneumatic, electromechanical, electric, and planetary electric two stage brake actuation systems described below. The method may further actuate any type of brake system, including a disc brake system and a drum brake system.

After the step of applying a second force to the push rod, the method may further include modulating the amount of the second force applied to the push rod in response to a signal from an anti-lock braking system (ABS). After the step of applying a first force to the push rod, the method may further include preventing movement of the push rod from the brake adjacent position in a direction toward the brake clearance position. After the step of applying a second force to the push rod, the method may further include releasing the second force from the push rod to move the push rod from the brake applied position to the brake adjacent position. After the step of releasing the second force from the push rod, the method may further include allowing movement of the push rod from the brake adjacent position in a direction toward the brake clearance position. After the step of allowing movement of the push rod, the method may further include releasing the first force from the push rod to move the push rod from the brake adjacent position to the brake clearance position.

A two stage brake actuation system in accordance with another aspect of the invention described herein includes a push rod, a first actuator that is coupled to the push rod, wherein the first actuator is operable to apply a first force to the push rod to move the push rod between a brake clearance position and a brake adjacent position, and a second actuator that is operable to apply a second force to the push rod to move the push rod between the brake adjacent position and a brake applied position. The first actuator may be a large displacement, low force actuator, and the second actuator may be a small displacement, high force actuator.

The two stage brake actuation system may be a pneumatic system in which the first and second actuators are each a pneumatic actuator. The first actuator including a first piston positioned within a first cylinder, wherein the first piston is coupled to the push rod. The first force is applied to the push rod when pressurized air is applied to one side of the piston. The second actuator includes a second piston positioned within a second cylinder. A lock assembly is coupled to at least one of the push rod and the second piston, wherein the lock assembly is operable to releasably lock the second piston to the push rod. The second force is applied to the push rod when pressurized air is applied to one side of the second piston and the second piston is releasably locked to the push rod.

Alternatively, the two stage brake actuation system may be an electromechanical system, wherein the first actuator is a pneumatic actuator as described above for the pneumatic system, and the second actuator includes an electric motor that is coupled to a worm gear. Worm threads are formed in the push rod, and the worm threads engage the worm gear. The electric motor applies the second force to the push rod by rotating the worm gear, which causes rotation of the push rod and movement of the push rod from the brake adjacent position to the brake applied position.

The two stage brake actuation system may be an electric system in which the first and second actuators are first and second electric motors, respectively, that are each coupled to the push rod. The push rod includes a threaded shaft that engages a threaded slide. The threaded shaft is coupled to the first electric motor in a manner that allows the first electric motor to rotate the threaded shaft. Rotation of the threaded shaft by the first electric motor causes the threaded slide to move between the brake clearance position and the brake adjacent position. The threaded shaft is coupled to the second electric motor in a manner that allows the second electric motor to rotate the threaded shaft. Rotation of the threaded shaft by the second electric motor causes the threaded slide to move between the brake adjacent position and the brake applied position.

A planetary electric two stage brake actuation system in accordance with another aspect of the invention described herein includes a push rod, a planetary gear assembly that is coupled to the push rod, and an electric motor that is coupled to the planetary gear assembly. The planetary gear assembly is operable in a first state that rotates a portion of the push rod at a first speed and at a first torque, and the planetary gear assembly is operable in a second state that rotates the portion of the push rod at a second speed and at a second torque. The first speed is greater than the second speed, and the first torque is less than the second torque. The push rod may include a threaded shaft that engages a threaded slide. The threaded shaft is coupled to the planetary gear assembly in a manner that allows the planetary gear assembly to rotate the threaded shaft when the electric motor is operated. Rotation of the threaded shaft when the planetary gear assembly is in the first state causes the threaded slide to move between a brake clearance position and a brake adjacent position. Rotation of the threaded shaft when the planetary gear assembly is in the second state causes the threaded slide to move between the brake adjacent position and a brake applied position.

Advantages of the two stage brake actuation systems and methods described herein include: less energy is needed to apply a vehicle's brakes than the energy needed with a conventional actuation system because in the present system a lower actuation force moves the actuator from the brake clearance position to the brake adjacent position; the systems adjust clearance between the brake pads/shoes and the brake disc/drum to account for brake pad/shoe wear without the use of a separate brake adjustment mechanism; the systems may be locked and held in the brake adjacent position without the use of an external energy storage system; the accuracy of brake modulation is improved with faster response time; smaller actuators may be used because less force is required as the actuator moves from the brake clearance position to the brake adjacent position; and improved fuel economy due to improved brake clearance control.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a schematic view of a pneumatic two stage brake actuation system;

FIG. 2 is a schematic view of an electromechanical two stage brake actuation system;

FIG. 3 is a schematic view of an electric two stage brake actuation system;

FIG. 4 is a schematic view of a planetary electric two stage brake actuation system;

FIG. 5 is a flow chart showing a method for braking a vehicle using a two stage brake actuation;

FIG. 6 is a graph showing force applied by a two stage brake actuation system over time; and

FIG. 7 is a graph showing force applied by a two stage brake actuation system and anti-lock braking system over time.

### DETAILED DESCRIPTION OF PREFERRED EMBODIMENT

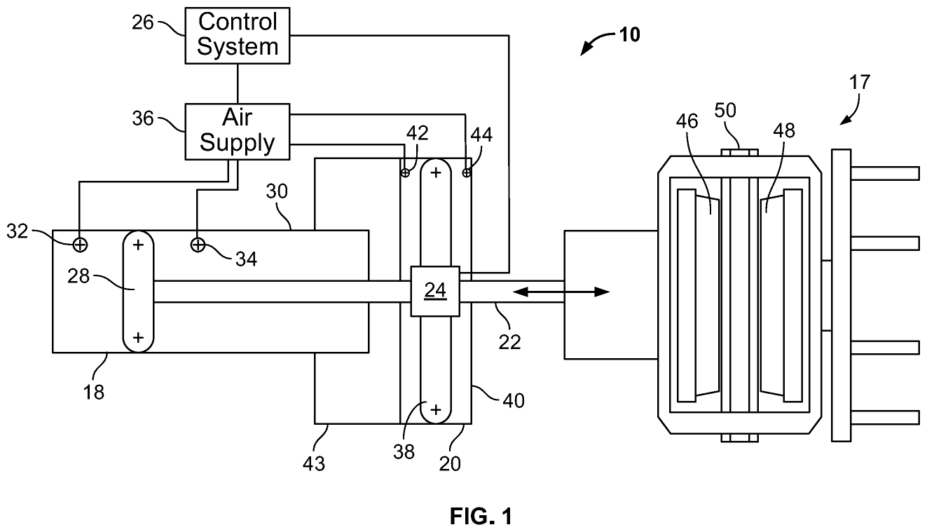

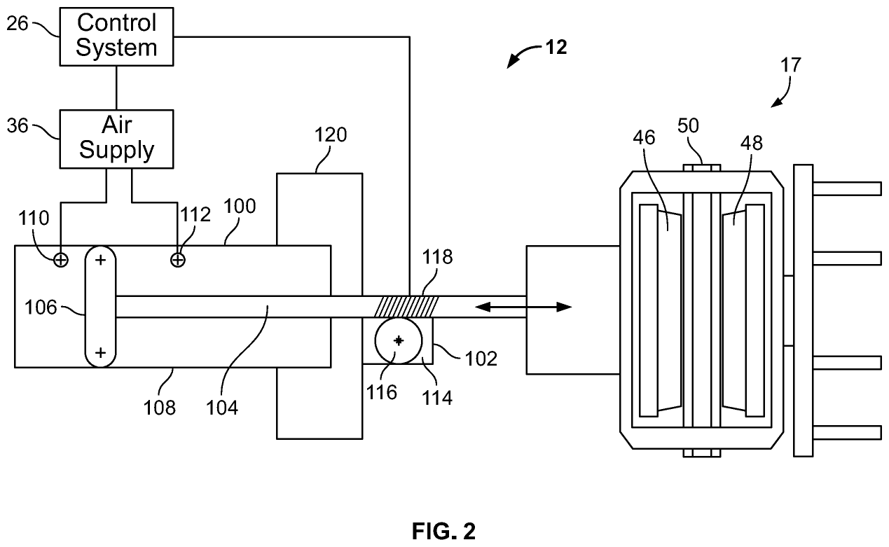

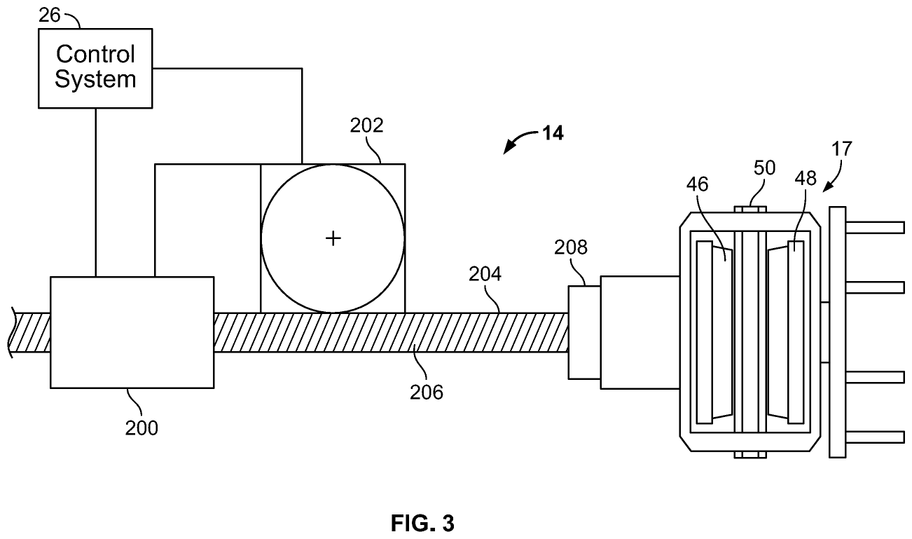

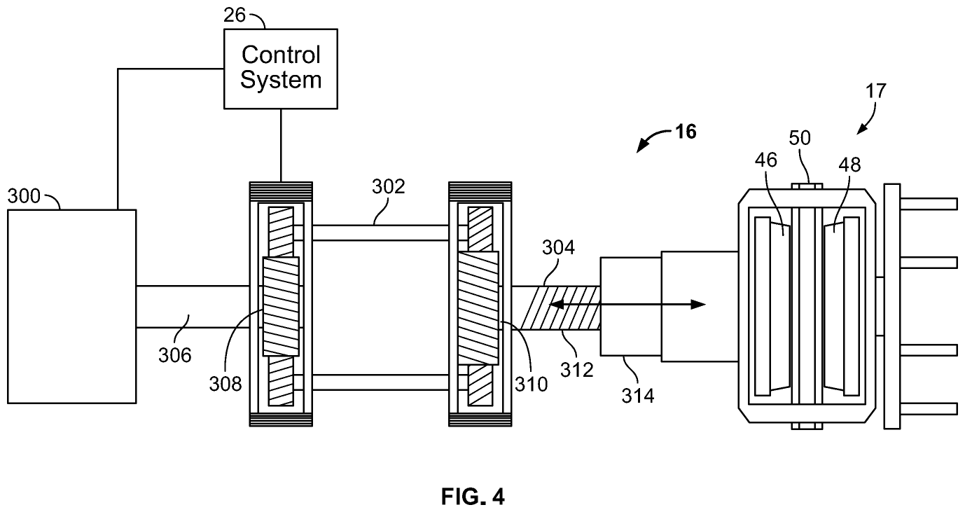

FIGS. 1-4 show four exemplary embodiments of two stage brake actuation systems in accordance with the invention described herein: a pneumatic system 10 (FIG. 1), an electromechanical system 12 (FIG. 2), an electric system 14 (FIG. 3), and a planetary electric system 16 (FIG. 4). Although FIGS. 1-4 show each of the systems 10, 12, 14, and 16 used to actuate a disc brake 17, the systems 10, 12, 14, and 16 may be used to actuate any type of brake, including a drum brake. Further, other types of two stage brake actuation systems are within the scope of the invention described and claimed herein.

Referring to FIG. 1, pneumatic system 10 includes a first actuator 18, a second actuator 20, a push rod 22, a lock assembly 24, and a control system 26. First actuator 18 is a pneumatic actuator that has a first piston 28 positioned within a first cylinder 30. First cylinder 30 includes a pair of air ports 32, 34 that are configured for connection to pressurized air supply 36 for moving first piston 28 within first cylinder 30 based on signals from control system 26. First piston 28 is joined to push rod 22.

Second actuator 20 is a pneumatic actuator that has a second piston 38 positioned within a second cylinder 40. Second piston 38 is releasably joined to push rod 22 with lock assembly 24. Second cylinder 40 includes a pair of air ports 42, 44 that are configured for connection to pressurized air supply 36 for moving second piston 38 within second cylinder 40 based on signals from control system 26. Second actuator 20 may be mounted to first actuator 18 with a mount 43.

Lock assembly 24 is coupled to at least one of push rod 22 and second piston 38. Lock assembly 24 is operable to releasably lock second piston 38 to push rod 22 based on signals from control system 26. When second piston 38 is locked to push rod 22, movement of second piston 38 also moves push rod 22, and when second piston 38 is not locked to push rod 22, push rod 22 moves independently from second piston 38. For example, lock assembly 24 may be joined to or integral with second piston 38, and push rod 22 may slide through an opening of lock assembly 24 when lock assembly 24 is not locked to push rod 22.

Control system 26 is operable to control the flow of air from pressurized air supply 36 to air ports 32, 34, 42 and 44 for moving first and second pistons 28 and 38 and push rod 22. Control system 26 is also operable to send a lock actuation signal to lock assembly 24 to actuate lock assembly 24 thereby locking second piston 38 to push rod 22 and a lock deactuation signal to deactuate lock assembly 24 thereby unlocking second piston 38 from push rod 22. Control system 26 may include a processor and memory with instructions that allow control system 26 to carry out the functions and send the signals described herein.

By controlling the flow of air to and from air ports 32 and 34, control system 26 is operable to move first piston 28 and push rod 22 from a brake clearance position, in which brake pads 46, 48 of disc brake 17 are not touching a brake disc 50, to a brake adjacent position, in which the brake pads 46, 48 just start to touch brake disc 50 but do not appreciably slow the rotation of brake disc 50. For example, control system 26 may send a valve open signal to a valve (not shown) that causes pressurized air from pressurized air supply 36 to enter air port 32 and move first piston 28 and push rod 22 toward disc brake 17. Push rod 22 is coupled to an actuation mechanism of disc brake 17 that causes brake pads 46, 48 to move toward brake disc 50 as push rod 22 moves toward disc brake 17. Control system 26 may receive inputs from a driver assistance system (not shown) that, for example, may sense a potential hazard on the road and instruct control system 26 to move push rod 22 and brake pads 46, 48 from the brake clearance position to the brake adjacent position. In this manner, if the driver then steps on a brake pedal to apply the vehicle's brakes (including disc brake 17) and slow the vehicle, it takes less time to stop the vehicle because the brake pads 46, 48 have already moved closer to the brake disc 50 from the brake clearance position to the brake adjacent position.

Further, when the push rod 22 and brake pads 46, 48 are in the brake adjacent position and lock assembly 24 locks second piston 38 to push rod 22, the control system 26 is operable to move second piston 38 and push rod 22 from the brake adjacent position to a brake applied position, in which brake pads 46, 48 apply a substantial amount of force to brake disc 50 to slow or stop the rotation of brake disc 50 and the vehicle. For example, control system 26 may send a valve open signal to a valve (not shown) that causes pressurized air from pressurized air supply 36 to enter air port 42 and move second piston 38 and push rod 22 toward disc brake 17, which also moves brake pads 46, 48 toward brake disc 50. Control system 26 may receive inputs from a driver assistance system (not shown) that, for example, may sense an imminent hazard on the road and instruct control system 26 to move push rod 22 and brake pads 46, 48 from the brake adjacent position to the brake applied position.

Control system 26 may move second piston 38 and push rod 22 from the brake applied position back to the brake adjacent position by, for example, sending a valve exhaust signal to exhaust air through air port 42. Further, control system 26 may send a valve open signal to a valve (not shown) that causes pressurized air from pressurized air supply 36 to enter air port 44 and move second piston 38 and push rod 22 away from disc brake 17. Alternatively, or in addition to sending air to air port 44, a spring or other biasing mechanism may move second piston 38 away from disc brake 17 when air is exhausted through air port 42. Moving push rod 22 away from disc brake 17 causes brake pads 46, 48 to move away from brake disc 50.

When lock assembly 24 is in the unlocked position and push rod 22 is in the brake adjacent position, control system 26 may likewise move first piston 28 and push rod 22 from the brake adjacent position back to the brake clearance position by, for example, sending a valve exhaust signal to exhaust air through air port 32. Further, control system 26 may send a valve open signal to a valve (not shown) that causes pressurized air from pressurized air supply 36 to enter air port 34 and move first piston 28 and push rod 22 away from disc brake 17. Alternatively, or in addition to sending air to air port 34, a spring or other biasing mechanism may move first piston 28 away from disc brake 17 when air is exhausted through air port 32. Lock assembly 24 may prevent movement of push rod 22 from the brake adjacent position to the brake clearance position when lock assembly 24 locks push rod 22 to second piston 38.

Control system 26 may include an anti-lock braking system (ABS) that is operable to control the flow of air to and from air ports 42 and 44 in a manner that rapidly moves push rod 22 toward and away from disc brake 17, as known in the art. For example, control system 26 may receive a signal from a wheel sensor (not shown), which indicates that a wheel has locked up or is skidding. Upon receipt of the signal, and when push rod 22 and brake pads 46, 48 are in the brake applied position, the ABS may send an ABS signal to a valve (not shown) that causes pressurized air to alternately exhaust from air port 42 and then enter air port 42. Further, air may enter air port 44 when it exhausts from air port 42 and exhaust from air port 44 when it enters air port 42. This causes push rod 22 to move away from and then toward disc brake 17. This movement causes brake pads 46, 48 to release pressure on brake disc 50 and then reapply pressure on brake disc 50. The ABS may cause alternating movement of push rod 22 away from and then toward disc brake 17 until the wheel sensor indicates that the wheel is no longer skidding.

First actuator 18 applies a first force to push rod 22 when pressurized air enters air port 32 to move the push rod 22 from the brake clearance position to the brake adjacent position. The first force is applied to push rod 22 when pressurized air is applied to the side of first piston 28 facing air port 32. Second actuator 20 applies a second force to push rod 22 when pressurized air enters air port 42 and second piston 38 is locked to push rod 22. The second force moves push rod 22 from the brake adjacent position to the brake applied position and is applied to push rod 22 when pressurized air is applied to the side of second piston 38 facing air port 42.

As compared to second actuator 20, first actuator 18 is a large displacement, low force actuator that is preferably operable to move the push rod 22 toward disc brake 17 from the brake clearance position to the brake adjacent position: (1) between approximately 3 to 0.17 inches at a force of between approximately 0 to 249 pounds; (2) approximately 3 inches at a force of approximately 249 pounds; or (3) approximately 2.5 inches at a force of approximately 249 pounds.

As compared to first actuator 18, second actuator 20 is a small displacement, high force actuator that when locked to push rod 22 with lock assembly 24 is preferably operable to move the push rod 22 toward disc brake 17 from the brake adjacent position to the brake applied position: (1) between approximately 0.17 to 0 inches at a force of between approximately 249 to 4359 pounds; (2) approximately 0.17 inches at a force of approximately 2157 pounds; or (3) approximately 0.17 inches at a force of approximately 4359 pounds.

In operation of the pneumatic system 10 shown in FIG. 1, to apply a vehicle's brakes, first actuator 18 moves push rod 22 a relatively long distance (from the brake clearance position to the brake adjacent position) at a relatively low level of force. Lock assembly 24 is actuated to releasably lock push rod 22 to second actuator 20. Second actuator 20 then moves push rod 22 a relatively short distance (from the brake adjacent position to the brake applied position) at a relatively high level of force. The vehicle's brakes are disengaged by releasing pressure from air port 42, and optionally sending pressurized air to air port 44, to move push rod 22 from the brake applied position to the brake adjacent position. Lock assembly 24 is deactuated, and then pressure is released from air port 32, and optionally air port 34 is pressurized, to move push rod 22 from the brake adjacent position to the brake clearance position. The ABS system may modulate the braking force when the push rod 22 is in the brake applied position.

Referring to FIG. 2, electromechanical system 12 includes a first actuator 100, a second actuator 102, a push rod 104, and a control system 26. First actuator 100 is a pneumatic actuator that has a piston 106 positioned within a cylinder 108. Cylinder 108 includes a pair of air ports 110, 112 that are configured for connection to pressurized air supply 36 for moving piston 106 within cylinder 108 based on signals from control system 26. Piston 106 is joined to push rod 104.

Second actuator 102 includes an electric motor 114 that is coupled to a worm gear 116. Worm threads 118 formed in push rod 104 engage worm gear 116. Electric motor 114 is operable to be releasably locked between unlocked and locked positions. When electric motor 114 is in the unlocked position, electric motor 114 permits rotation of worm gear 116 with very little to no resistance. For example, when first actuator 100 moves push rod 104 toward disc brake 17, electric motor 114 is preferably unlocked allowing first actuator 100 to move push rod 104 with very little to no resistance from electric motor 114. When in the locked position, electric motor 114 substantially prevents translational movement of push rod 104 unless electric motor 114 is operating to rotate worm gear 116. Second actuator 102 may be mounted to first actuator 100 with a mount 120.

Control system 26 is operable to control the flow of air from pressurized air supply 36 to air ports 110, 112 for moving piston 106 and push rod 104. Control system 26 is also operable to send a brake actuation signal to electric motor 114 to rotate worm gear 116 in a first direction that causes movement of push rod 104 toward disc brake 17 and in a second direction that causes movement of push rod 104 away from disc brake 17. Control system 26 is further operable to send lock actuation and deactuation signals to electric motor 114 to switch electric motor 114 between the locked and unlocked positions.

By controlling the flow of air to and from air ports 110 and 112, control system 26 is operable to move piston 106 and push rod 104 from a brake clearance position, in which brake pads 46, 48 are not touching brake disc 50, to a brake adjacent position, in which the brake pads 46, 48 just start to touch brake disc 50 but do not appreciably slow the rotation of brake disc 50. Control system 26 may move piston 106 and push rod 104 in the same manner as described above with respect to pneumatic system 10.

When push rod 104 and brake pads 46, 48 are in the brake adjacent position, the control system 26 is operable to move push rod 104 from the brake adjacent position to a brake applied position, in which brake pads 46, 48 apply a substantial amount of force to brake disc 50 to slow or stop the rotation of brake disc 50 and the vehicle. Control system 26 sends a brake actuation signal to electric motor 114 to rotate worm gear 116 in a first direction. Worm gear 116 engages the threads 118 on push rod 104 causing push rod 104 to rotate and move toward disc brake 17, which also causes brake pads 46, 48 to move toward brake disc 50. As described above with respect to pneumatic system 10, control system 26 may receive inputs from a driver assistance system (not shown) that causes control system 26 to move push rod 104 from the brake clearance position to the brake adjacent position and then to the brake applied position.

Control system 26 may move push rod 104 from the brake applied position back to the brake adjacent position by sending a brake deactuation signal to electric motor 114 to rotate worm gear 116 in a second direction opposite to the first direction. Worm gear 116 engages the threads 118 on push rod 104 causing push rod 104 to rotate and move away from disc brake 17, which also causes brake pads 46, 48 to move away from brake disc 50.

When electric motor 114 is unlocked and push rod 104 is in the brake adjacent position, control system 26 may likewise move piston 106 and push rod 104 from the brake adjacent position back to the brake clearance position in the same manner as described above for pneumatic system 10. Electric motor 114 may prevent movement of push rod 104 from the brake adjacent position to the brake clearance position when electric motor 114 is in the locked position.

First actuator 100 applies a first force to push rod 104 when pressurized air enters air port 110 to move the push rod 104 from the brake clearance position to the brake adjacent position, as described above with respect to pneumatic system 10. Second actuator 102 applies a second torque to push rod 104 when electric motor 114 rotates worm gear 116, which rotates push rod 104 moving push rod 104 from the brake adjacent position to the brake applied position. As push rod 104 moves toward disc brake 17, it applies a second force to an actuation mechanism of disc brake 17 to move brake pads 46, 48 to the brake applied position described above in connection with pneumatic system 10. First actuator 100 preferably moves push rod 104 from the brake clearance position to the brake adjacent position in accordance with the distances and forces described above for pneumatic system 10. Second actuator 102 preferably moves push rod 104 from the brake adjacent position to the brake applied position in accordance with the distances and forces described above for pneumatic system 10.

In operation of the electromechanical system 12 shown in FIG. 2, to apply a vehicle's brakes, first actuator 100 moves push rod 104 a relatively long distance (from a brake clearance position to a brake adjacent position) at a relatively low level of force. During movement of first actuator 100, electric motor 114 has a free turning shaft with very low resistance. After movement of push rod 104 to the brake adjacent position, a lock actuation signal is sent to electric motor 114 to prevent movement of push rod 104 back toward the brake clearance position. Electric motor 114 then moves push rod 104 a relatively short distance (from the brake adjacent position to a brake applied position) at a relatively high level of force. The brakes are disengaged by rotating electric motor 114 in the reverse direction to move push rod 104 from the brake applied position to the brake adjacent position. A lock deactuation signal is sent to electric motor 114 to allow movement of push rod 104 back to the brake clearance position. Then, pressure is released from air port 110, and optionally air port 112 is pressurized, to move push rod 104 from the brake adjacent position to the brake clearance position.

The electric system 14 shown in FIG. 3 includes a first actuator 200, a second actuator 202, a push rod 204, and a control system 26. First actuator 200 is an electric motor that may operate at a relatively low torque and high revolutions per minute (RPM). Second actuator 202 is an electric motor that may operate at a relatively high torque and low RPM. Push rod 204 includes a threaded shaft 206 and a threaded slide 208 that engages the threaded shaft 206. When threaded shaft 206 is rotated in a first direction, threaded slide 208 moves toward disc brake 17, and when threaded shaft 206 is rotated in a second direction opposite to the first direction, threaded slide 208 moves away from disc brake 17. First actuator 200 engages threaded shaft 206 in a manner that allows first actuator 200 to rotate the threaded shaft 206 in the first direction and the second direction. Likewise, second actuator 202 engages threaded shaft 206 in a manner that allows second actuator 202 to rotate threaded shaft 206 in the first direction and the second direction. Second actuator 202 is operable to be releasably locked between unlocked and locked positions in a similar manner as described above for electric motor 114. When second actuator 202 is in the unlocked position, second actuator 202 permits rotation of threaded shaft 206 by first actuator 200 with very little to no resistance. When second actuator 202 is in the locked position, second actuator 202 substantially prevents rotation of threaded shaft 206 by first actuator 200.

Control system 26 is operable to send a brake actuation signal to first actuator 200 to rotate the threaded shaft 206 in the first direction and a brake deactuation signal to first actuator 200 to rotate threaded shaft 206 in the second direction. Likewise, control system 26 is operable to send a brake actuation signal to second actuator 202 to rotate the threaded shaft 206 in the first direction and a brake deactuation signal to second actuator 202 to rotate threaded shaft 206 in the second direction. Control system 26 is further operable to send lock actuation and deactuation signals to second actuator 202 to switch second actuator 202 between the locked and unlocked positions.

By sending a brake actuation signal that causes first actuator 200 to rotate threaded shaft 206 in the first direction, control system 26 is operable to move threaded slide 208 from a brake clearance position, in which brake pads 46, 48 are not touching brake disc 50, to a brake adjacent position, in which the brake pads 46, 48 just start to touch brake disc 50 but do not appreciably slow the rotation of brake disc 50. When threaded slide 208 is in the brake adjacent position, control system 26 is operable to move threaded slide 208 from the brake adjacent position to the brake applied position described above by sending a brake actuation signal that causes second actuator 202 to rotate in the first direction. As described above with respect to pneumatic system 10, control system 26 may receive inputs from a driver assistance system (not shown) that causes control system 26 to move threaded slide 208 from the brake clearance position to the brake adjacent position and then to the brake applied position.

Control system 26 may move threaded slide 208 from the brake applied position back to the brake adjacent position by sending a brake deactuation signal to second actuator 202 to rotate threaded shaft 206 in the second direction. When second actuator 202 is unlocked and threaded slide 208 is in the brake adjacent position, control system 26 may move threaded slide 208 from the brake adjacent position back to the brake clearance position by sending a brake deactuation signal to first actuator 200. Second actuator 202 may prevent movement of threaded slide 208 from the brake adjacent position to the brake clearance position when second actuator 202 is in the locked position.

When control system 26 sends the brake actuation signal to first actuator 200, first actuator 200 applies a first torque to threaded shaft 206. Threaded shaft 206 then applies a torque to threaded slide 208 to move threaded slide 208 from the brake clearance position to the brake adjacent position. As it moves, threaded slide 208 applies a first force to an actuation mechanism of disc brake 17 to move brake pads 46, 48 to the brake adjacent position described above in connection with pneumatic system 10. When control system 26 sends the brake actuation signal to second actuator 102, second actuator 102 applies a second torque to threaded shaft 206. Threaded shaft 206 then applies a torque to threaded slide 208 to move threaded slide 208 from the brake adjacent position to the brake applied position. As it moves, threaded slide 208 applies a second force to an actuation mechanism of disc brake 17 to move brake pads 46, 48 to the brake applied position described above in connection with pneumatic system 10. First actuator 200 preferably moves threaded slide 208 from the brake clearance position to the brake adjacent position in accordance with the distances and forces described above for pneumatic system 10. Second actuator 202 preferably moves threaded slide 208 from the brake adjacent position to the brake applied position in accordance with the distances and forces described above for pneumatic system 10.

In operation of the electric system 14 shown in FIG. 3, to apply a vehicle's brakes, first actuator 200 rotates threaded shaft 206 in a first direction at a relatively low torque and high RPM to move threaded slide 208 a relatively long distance (from the brake clearance position to the brake applied position) at a relatively low level of force. Second actuator 202 has a free turning shaft with low resistance during this operation of first actuator 200. After movement of threaded slide 208 to the brake adjacent position, a lock actuation signal is sent to second actuator 202 to prevent movement of threaded slide 208 back toward the brake clearance position. Second actuator 202 then rotates threaded shaft 206 in the first direction at a relatively high torque and low RPM to move threaded slide 208 a relatively short distance (from the brake adjacent position to a brake applied position) at a relatively high level of force. The vehicle's brakes are disengaged by rotating threaded shaft 206 with second actuator 202 in the reverse direction to move threaded slide 208 from the brake applied position to the brake adjacent position. A lock deactuation signal is sent to second actuator 202 to set it in the unlocked position. Then, first actuator 200 rotates threaded shaft 206 in the reverse direction to move threaded slide 208 from the brake adjacent position to the brake clearance position.

Referring to FIG. 4, planetary electric system 16 includes an electric motor 300, a planetary gear assembly 302, a push rod 304, and a control system 26. Electric motor 300 is coupled via a shaft 306 to an input 308 of planetary gear assembly 302. Electric motor 300 is operable to rotate shaft 306 in a first direction and in a second direction opposite to the first direction. An output 310 of planetary gear assembly 302 is coupled to a threaded shaft 312 of push rod 304. Push rod 304 further includes a threaded slide 314 that is coupled to threaded shaft 312. When shaft 306 rotates in the first direction, planetary gear assembly 302 rotates threaded shaft 312 in the first direction and threaded slide 314 moves toward disc brake 17. When shaft 306 rotates in the second direction, planetary gear assembly 302 rotates threaded shaft 312 in the second direction opposite to the first direction and threaded slide 314 moves away from disc brake 17.

Planetary gear assembly 302 is operable in a first state, in which output 310 rotates threaded shaft 312 at a first speed and at a first torque, and a second state, in which output 310 rotates threaded shaft 312 at a second speed and at a second torque. The first speed is greater than the second speed, and the first torque is less than the second torque.

Control system 26 is operable to send a brake actuation signal to electric motor 300 that rotates shaft 306 in the first direction and a brake deactuation signal to electric motor 300 that rotates shaft 306 in the second direction. Control system 26 is further operable to send a lock actuation signal to planetary gear assembly 302 to switch planetary gear assembly 302 from the first state (high RPM and low torque) to the second state (low RPM and high torque) and a lock deactuation signal to planetary gear assembly 302 to switch planetary gear assembly from the second state to the first state.

When control system 26 sends a brake actuation signal to electric motor 300 and planetary gear assembly 302 is in the first state, threaded slide 314 moves from a brake clearance position, in which brake pads 46, 48 are not touching brake disc 50, to a brake adjacent position, in which the brake pads 46, 48 just start to touch brake disc 50 but do not appreciably slow the rotation of brake disc 50. When control system 26 sends a brake actuation signal to electric motor 300 and a lock actuation signal to switch planetary gear assembly 302 from the first state to the second state, threaded slide 314 moves from the brake adjacent position to the brake applied position described above. As described above with respect to pneumatic system 10, control system 26 may receive inputs from a driver assistance system (not shown) that causes control system 26 to move threaded slide 314 from the brake clearance position to the brake adjacent position and then to the brake applied position.

Control system 26 may move threaded slide 314 from the brake applied position back to the brake adjacent position by sending a brake deactuation signal to electric motor 300 to rotate shaft 306 in the second direction. Likewise, control system 26 may move threaded slide 314 from the brake adjacent position back to the brake clearance position by sending a brake deactuation signal to electric motor 300 to rotate shaft 306 in the second direction. Planetary gear assembly 302 may be set in the first state or the second state as shaft 306 rotates in the second direction. Alternatively, planetary gear assembly 302 may prevent movement of threaded slide 314 from the brake adjacent position to the brake clearance position when planetary gear assembly 302 is set in the second state.

When control system 26 sends the brake actuation signal to electric motor 300 and planetary gear assembly 302 is set in the first state, planetary gear assembly 302 applies a first torque to threaded shaft 312. Threaded shaft 312 then applies a torque to threaded slide 314 to move threaded slide 314 from the brake clearance position to the brake adjacent position. As it moves, threaded slide 314 applies a first force to an actuation mechanism of disc brake 17 to move brake pads 46, 48 to the brake adjacent position described above in connection with pneumatic system 10. When control system 26 sends the brake actuation signal to electric motor 300 and planetary gear assembly 302 is set in the second state, planetary gear assembly applies a second torque to threaded shaft 312. Threaded shaft 312 then applies a torque to threaded slide 314 to move threaded slide 314 from the brake adjacent position to the brake applied position. As it moves, threaded slide 314 applies a second force to an actuation mechanism of disc brake 17 to move brake pads 46, 48 to the brake applied position described above in connection with pneumatic system 10. Electric motor 300 and planetary gear assembly 302, when set in its first state, preferably move threaded slide 314 from the brake clearance position to the brake adjacent position in accordance with the distances and forces described above for pneumatic system 10. Electric motor 300 and planetary gear assembly 302, when set in its second state, preferably move threaded slide 314 from the brake adjacent position to the brake applied position in accordance with the distances and forces described above for pneumatic system 10.

In operation of the planetary electric system 16 shown in FIG. 4, to apply a vehicle's brakes, planetary gear assembly 302 is set in its first state and electric motor 300 rotates shaft 306 and the input 308 of planetary gear assembly 302. This rotates the output 310 of planetary gear assembly 302 and threaded shaft 312 at a relatively high RPM and low torque. Rotation of threaded shaft 312 moves threaded slide 314 toward disc brake 17 a relatively long distance (from the brake clearance position to the brake adjacent position) at a relatively low level of force. Planetary gear assembly 302 is then set in the second state, which prevents movement of threaded slide 314 back toward the brake clearance position. Electric motor 300 rotates shaft 306 and the input 308 of planetary gear assembly 302. This rotates the output 310 of planetary gear assembly 302 and threaded shaft 312 at a relatively low RPM and high torque. Rotation of threaded shaft 312 moves threaded slide 314 toward disc brake 17 a relatively short distance (from the brake adjacent position to the brake applied position) at a relatively high level of force. The brakes are disengaged by setting planetary gear assembly 302 in its first state and rotating electric motor 300 in the reverse direction to rotate threaded shaft 312 and move threaded slide 314 from the brake applied position to the brake adjacent position and the brake clearance position.

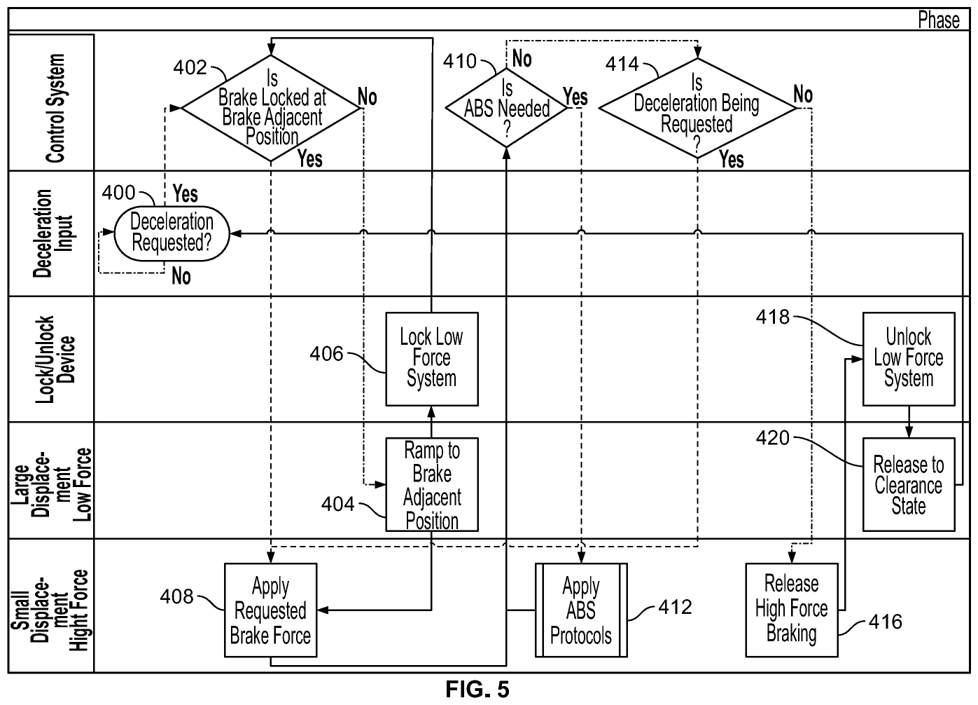

A method for braking a vehicle in accordance with the invention described herein is illustrated in FIG. 5. The method shown in FIG. 5 may be carried out by any of the pneumatic system 10, electromechanical system 12, electric system 14, and planetary electric system 16 shown in FIGS. 1-4. Further, the method shown in FIG. 5 may be carried out by any other suitable two stage brake actuation system. The method shown in FIG. 5 may be carried out by a control system, like control system 26 described above, that includes a processor and a memory that is programmed with instructions that the processor follows to send signals to brake system components for carrying out the steps described below. The method may be used with any type of brake system including a disc brake system and a drum brake system.

The method for braking a vehicle begins when deceleration is requested at step 400 and the brake system of the vehicle is in the brake clearance position described above. As described above in connection with the pneumatic system 10, control system 26 may receive the deceleration request from a driver assistance system that senses a potential road hazard. The decleration request may also be received from a driver of the vehicle or from an adjacent vehicle on the road. When decleration is requested, at step 402, a determination is made as to whether the brake system is locked in the brake adjacent position described above. If the brake system is not locked in the brake adjacent position, at step 404, a brake actuation signal is sent to the brake system to move it from the brake clearance position to the brake adjacent position. As described above, the actuation mechanism of the brake system moves a relatively large distance at a low level of force from the brake clearance position to the brake adjacent position. Next, at step 406, the brake system is locked in the brake adjacent position to prevent it from moving back to the brake clearance position.

The method then moves back to step 402 where it is determined that the brake system is locked in the brake adjacent position. At step 408, a brake actuation signal is sent to the brake system to move it from the brake adjacent position to the brake applied position, as described above. The actuation mechanism of the brake system moves a relatively short distance at a high level of force from the brake adjacent position to the brake applied position. While the brake system is in the brake applied position, the method moves to step 410 to determine whether ABS should be actuated. If an ABS signal is received at step 410, ABS is actuated at step 412 as described above to prevent wheel skidding by rapidly decreasing and increasing the applied brake force. Further, while the brake system is in the brake applied position, at step 414, the control system determines whether deceleration is still being requested. If deceleration is still being requested, the brake system remains in the brake applied position applying the requested braking force at step 408.

If deceleration is not still being requested, the method moves to step 416. At step 416, a brake deactuation signal is sent to the brake system to move the brake system from the brake applied position back to the brake adjacent position. Next, at step 418, the brake system is unlocked to permit movement back to the brake clearance position. At step 420, a brake deactuation signal is sent to the brake system to move the brake system from the brake adjacent position back to the brake clearance position.

As an alternative to what is shown in FIG. 5, at step 404, the method may hold the brake system in the brake adjacent position until a brake actuation signal is sent by the control system to move the brake system to the brake applied position at step 408. If the brake actuation signal is not sent, the control system may send a brake deactuation signal to move the brake system back to the brake clearance position. Further, after step 416, the method may hold the brake system in the brake adjacent position until a brake deactuation signal is sent by the control system to move the brake system to the brake clearance position at step 420.

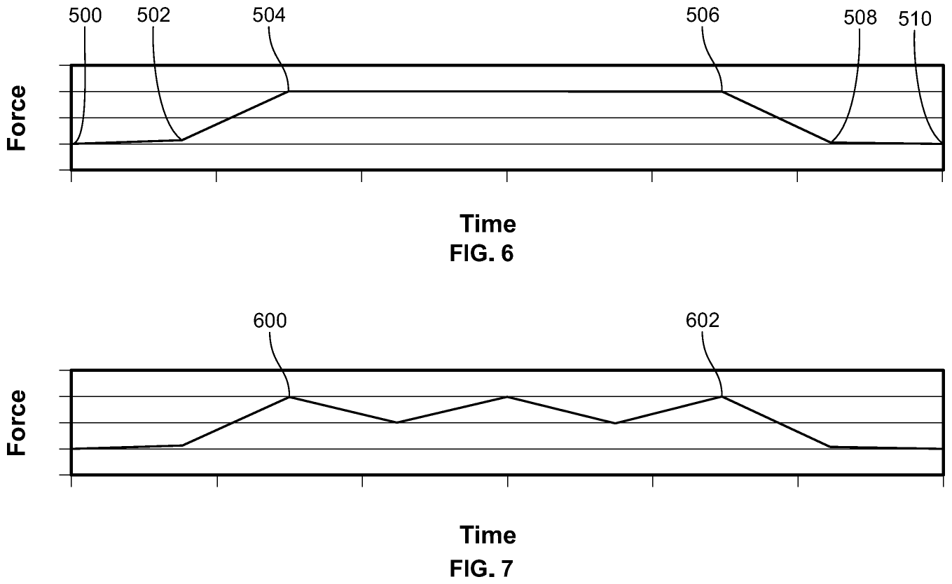

FIG. 6 is a graph showing representative levels of force applied by a two stage brake actuation system over time as the brake system applies a brake force and stops applying the brake force. The pneumatic system 10, electromechanical system 12, electric system 14, and planetary electric system 16 shown in FIGS. 1-4 may be operated to apply brake force over time as shown in FIG. 6, and FIG. 6 may be representative of brake force over time applied by the method shown in FIG. 5. At point 500 in FIG. 6, the brake system is in the brake clearance position and is unlocked. From point 500 to point 502, the brake system moves from the brake clearance position to the brake adjacent position. As shown, a relatively low amount of force is necessary to move the brake system to the brake adjacent position. The brake system may be locked at point 502 to prevent movement back to the brake clearance position. From point 502 to point 504, the brake system moves from the brake adjacent position to the brake applied position. As shown, a relatively high amount of force is necessary to move the brake system to the brake applied position, as compared to the amount of force necessary to move the brake system from the brake clearance position to the brake adjacent position. From point 504 to point 506, the brake system remains in the brake applied position to slow or stop the vehicle as desired. Further, from point 504 to point 506, an ABS system may modulate the braking force as desired to prevent wheel skidding. From point 506 to point 508, the brake system moves from the brake applied position to the brake adjacent position. At point 508, the brake system is unlocked allowing it to move to the brake clearance position. From point 508 to point 510 the brake system moves from the brake adjacent position to the brake clearance position. At point 510, the brake system may be locked to prevent its movement to the brake adjacent position.

FIG. 7 is a graph that is similar to FIG. 6 except that as the brake system remains in the brake applied position, from point 600 to 602, the brake force is modulated over time so that a desired brake force is applied to the wheels of the vehicle. The brake force may modulate in accordance with actuation of an ABS system and/or as desired due to inputs from a driver or driver assistance system.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

We claim:

1. A method for braking a vehicle comprising:
applying a first force to a push rod to move the push rod a first distance from a brake clearance position to a brake adjacent position; and
applying a second force to the push rod to move the push rod a second distance from the brake adjacent position to a brake applied position.

2. The method of claim 1, wherein the first force is less than the second force, and wherein the first distance is greater than the second distance.

3. The method of claim 2, wherein the first force is between approximately 0 to 249 pounds, wherein the second force is between approximately 249 to 4359 pounds, wherein the first distance is between approximately 3.0 to 0.17 inches, and wherein the second distance is between approximately 0.17 to 0 inches.

4. The method of claim 3, wherein the first force is approximately 249 pounds, wherein the second force is approximately 2157 pounds, wherein the first distance is approximately 2.5 inches, and wherein the second distance is approximately 0.17 inches.

5. The method of claim 3, wherein the first force is approximately 249 pounds, wherein the second force is approximately 4359 pounds, wherein the first distance is approximately 3.0 inches, and wherein the second distance is approximately 0.17 inches.

6. The method of claim 1, further comprising, after the step of applying a first force to the push rod, preventing movement of the push rod from the brake adjacent position in a direction toward the brake clearance position.

7. The method of claim 6, further comprising, after the step of applying a second force to the push rod, releasing the second force from the push rod to move the push rod from the brake applied position to the brake adjacent position.

8. The method of claim 7, further comprising, after the step of releasing the second force from the push rod, allowing movement of the push rod from the brake adjacent position in a direction toward the brake clearance position.

9. The method of claim 8, further comprising, after the step of allowing movement of the push rod, releasing the first force from the push rod to move the push rod from the brake adjacent position to the brake clearance position.

10. The method of claim 1, further comprising, after the step of applying a second force to the push rod, modulating the amount of the second force applied to the push rod in response to a signal from an anti-lock braking system (ABS).

11. The method of claim 1, further comprising providing a pneumatic actuator comprising a piston that is positioned within a cylinder, wherein the piston is coupled to the push rod, and wherein the first force is applied to the push rod when pressurized air is applied to one side of the piston.

12. The method of claim 11, further comprising providing a second pneumatic actuator comprising a second piston that is positioned within a second cylinder, wherein the second piston is operable to be releasably locked to the push rod, and wherein the second force is applied to the push rod when pressurized air is applied to one side of the second piston and the second piston is releasably locked to the push rod.

13. The method of claim 12, wherein releasably locking the second piston to the push rod after applying the first force to the push rod prevents movement of the push rod from the brake adjacent position in a direction toward the brake clearance position.

14. The method of claim 13, further comprising:
releasing the second force to move the push rod from the brake applied position to the brake adjacent position;
unlocking the second piston from the push rod; and
releasing the first force to move the push rod from the brake adjacent position to the brake clearance position.

15. The method of claim 11, further comprising providing an electric motor, a worm gear that is coupled to the electric motor, and worm threads that are formed in the push rod and that engage the worm gear, and wherein the electric motor applies the second force to the push rod by rotating the worm gear, which causes rotation of the push rod and movement of the push rod from the brake adjacent position to the brake applied position.

16. The method of claim 15, further comprising releasably locking the electric motor after applying the first force to the push rod to prevent movement of the push rod from the brake adjacent position in a direction toward the brake clearance position.

17. The method of claim 16, further comprising:
releasing the second force by operating the electric motor to move the push rod from the brake applied position to the brake adjacent position;
unlocking the electric motor to allow movement of the push rod from the brake adjacent position in a direction toward the brake clearance position; and
releasing the first force to move the push rod from the brake adjacent position to the brake clearance position.

18. The method of claim 1, further comprising providing a first electric motor that is coupled to the push rod and that is operable to move the push rod from the brake clearance position to the brake adjacent position, wherein the first electric motor applies the first force to the push rod.

19. The method of claim 18, further comprising providing a second electric motor that is coupled to the push rod and that is operable to move the push rod from the brake adjacent position to the brake applied position, wherein the second electric motor applies the second force to the push rod.

20. The method of claim 19, wherein the push rod comprises a threaded shaft that engages a threaded slide, wherein the threaded shaft is coupled to the first electric motor in a manner that allows the first electric motor to rotate the threaded shaft, and wherein rotation of the threaded shaft by the first electric motor causes the threaded slide to move between the brake clearance position and the brake adjacent position.

21. The method of claim 20, wherein the threaded shaft is coupled to the second electric motor in a manner that allows the second electric motor to rotate the threaded shaft, and wherein rotation of the threaded shaft by the second electric motor causes the threaded slide to move between the brake adjacent position and the brake applied position.

22. The method of claim 21, further comprising releasably locking the second electric motor after applying the first force to the push rod to prevent movement of the push rod from the brake adjacent position in a direction toward the brake clearance position.

23. The method of claim 22, further comprising:
releasing the second force by operating the second electric motor to move the push rod from the brake applied position to the brake adjacent position;
unlocking the second electric motor to allow movement of the push rod from the brake adjacent position in a direction toward the brake clearance position; and
releasing the first force by operating the first electric motor to move the push rod from the brake adjacent position to the brake clearance position.

24. The method of claim 1, further comprising providing an electric motor and a planetary gear assembly that is coupled to the electric motor and to the push rod, wherein operation of the electric motor when the planetary gear assembly is in a first state causes the planetary gear assembly to apply the first force to the push rod, and wherein operation of the electric motor when the planetary gear assembly is in a second state causes the planetary gear assembly to apply the second force to the push rod.

25. The method of claim 24, wherein the push rod comprises a threaded shaft that engages a threaded slide, wherein the threaded shaft is coupled to the planetary gear assembly in a manner that allows the planetary gear assembly to rotate the threaded shaft when the electric motor is operated, wherein rotation of the threaded shaft by the electric motor when the planetary gear assembly is in the first state causes the threaded slide to move between the brake clearance position and the brake adjacent position, and wherein rotation of the threaded shaft by the electric motor when the planetary gear assembly is in the second state causes the threaded slide to move between the brake adjacent position and the brake applied position.

26. The method of claim 25, further comprising changing the planetary gear assembly from the first state to the second state after applying the first force to the push rod to prevent movement of the push rod from the brake adjacent position in a direction toward the brake clearance position.

27. The method of claim 26, further comprising:
releasing the second force by operating the electric motor to move the push rod from the brake applied position to the brake adjacent position;
changing the planetary gear assembly from the second state to the first state to allow movement of the push rod from the brake adjacent position in a direction toward the brake clearance position; and
releasing the first force by operating the electric motor to move the push rod from the brake adjacent position to the brake clearance position.

28. A two stage brake actuation system comprising:
a push rod;
a first actuator that is coupled to the push rod, wherein the first actuator is operable to apply a first force to the push rod to move the push rod between a brake clearance position and a brake adjacent position; and
a second actuator that is operable to apply a second force to the push rod to move the push rod between the brake adjacent position and a brake applied position.

29. The system of claim 28, wherein the first actuator is a pneumatic actuator comprising a first piston positioned within a first cylinder, wherein the first piston is coupled to the push rod, and wherein the first force is applied to the push rod when pressurized air is applied to one side of the piston.

30. The system of claim 29, wherein the second actuator is a pneumatic actuator comprising a second piston positioned within a second cylinder, and further comprising a lock assembly that is coupled to at least one of the push rod and the second piston, wherein the lock assembly is operable to releasably lock the second piston to the push rod, and wherein the second force is applied to the push rod when pressurized air is applied to one side of the second piston and the second piston is releasably locked to the push rod.

31. The system of claim 30, wherein releasably locking the second piston to the push rod after applying the first force to the push rod prevents movement of the push rod from the brake adjacent position in a direction toward the brake clearance position.

32. The system of claim 31, further comprising a control system that is operable to control the flow of air from a pressurized air supply to the first actuator to move the push rod between the brake clearance position and the brake adjacent position, wherein the control system is operable to send a lock actuation signal to the lock assembly to releasably lock the second piston to the push rod, and wherein the control system is operable to control the flow of air from the pressurized air supply to the second actuator to move the push rod between the brake adjacent position and the brake applied position.

33. The system of claim 29, wherein the second actuator comprises an electric motor that is coupled to a worm gear, wherein worm threads are formed in the push rod, wherein the worm threads engage the worm gear, and wherein the electric motor applies the second force to the push rod by rotating the worm gear, which causes rotation of the push rod and movement of the push rod from the brake adjacent position to the brake applied position.

34. The system of claim 33, wherein the electric motor is operable to be releasably locked to prevent movement of the push rod from the brake adjacent position in a direction toward the brake clearance position.

35. The system of claim 34, further comprising a control system that is operable to control the flow of air from a pressurized air supply to the first actuator to move the push rod between the brake clearance position and the brake adjacent position, wherein the control system is operable to send a lock actuation signal to the second actuator to releasably lock the electric motor, and wherein the control system is operable to send a brake actuation signal to the second actuator to move the push rod from the brake adjacent position to the brake applied position.

36. The system of claim 28, wherein the first actuator comprises a first electric motor that is coupled to the push rod, and wherein the second actuator comprises a second electric motor that is coupled to the push rod.

37. The system of claim 36, wherein the push rod comprises a threaded shaft that engages a threaded slide, wherein the threaded shaft is coupled to the first electric motor in a manner that allows the first electric motor to rotate the threaded shaft, and wherein rotation of the threaded shaft by the first electric motor causes the threaded slide to move between the brake clearance position and the brake adjacent position.

38. The system of claim 37, wherein the threaded shaft is coupled to the second electric motor in a manner that allows the second electric motor to rotate the threaded shaft, and wherein rotation of the threaded shaft by the second electric motor causes the threaded slide to move between the brake adjacent position and the brake applied position.

39. The system of claim 38, wherein the second electric motor is operable to be releasably locked to prevent movement of the push rod from the brake adjacent position in a direction toward the brake clearance position.

40. The system of claim 39, further comprising a control system that is operable to send a brake actuation signal to the first actuator to move the push rod from the brake clearance position to the brake adjacent position, wherein the control system is operable to send a lock actuation signal to the second actuator to releasably lock the second electric motor, and wherein the control system is operable to send a second brake actuation signal to the second actuator to move the push rod from the brake adjacent position to the brake applied position.

41. The system of claim 28, wherein the first actuator is a large displacement, low force actuator.

42. The system of claim 41, wherein the first actuator is operable to move the push rod between approximately 3 to 0.17 inches at a force of between approximately 0 to 249 pounds.

43. The system of claim 42, wherein the first actuator is operable to move the push rod approximately 3 inches at a force of approximately 249 pounds.

44. The system of claim 42, wherein the first actuator is operable to move the push rod approximately 2.5 inches at a force of approximately 249 pounds.

45. The system of claim 41, wherein the second actuator is a small displacement, high force actuator.

46. The system of claim 45, wherein the second actuator is operable to move the push rod between approximately 0.17 to 0 inches at a force of between approximately 249 to 4359 pounds.

47. The system of claim 46, wherein the second actuator is operable to move the push rod approximately 0.17 inches at a force of approximately 2157 pounds.

48. The system of claim 46, wherein the second actuator is operable to move the push rod approximately 0.17 inches at a force of approximately 4359 pounds.

49. The system of claim 28, further comprising an anti-lock braking system (ABS) that is operable to modulate the amount of the second force applied to the push rod by the second actuator.

50. A two stage brake actuation system comprising:
a push rod;
a planetary gear assembly that is coupled to the push rod, wherein the planetary gear assembly is operable in a first state that rotates a portion of the push rod at a first speed and at a first torque, and wherein the planetary gear assembly is operable in a second state that rotates the portion of the push rod at a second speed and at a second torque, wherein the first speed is greater than the second speed, and wherein the first torque is less than the second torque; and
an electric motor that is coupled to the planetary gear assembly.

51. The system of claim 50, wherein the push rod comprises a threaded shaft that engages a threaded slide, wherein the threaded shaft is coupled to the planetary gear assembly in a manner that allows the planetary gear assembly to rotate the threaded shaft when the electric motor is operated, wherein rotation of the threaded shaft when the planetary gear assembly is in the first state causes the threaded slide to move between a brake clearance position and a brake adjacent position, and wherein rotation of the threaded shaft when the planetary gear assembly is in the second state causes the threaded slide to move between the brake adjacent position and a brake applied position.

52. The system of claim 51, wherein when the planetary gear assembly is in the second state, the planetary gear assembly is operable to prevent movement of the push rod from the brake adjacent position in a direction toward the brake clearance position.

53. The system of claim 51, wherein the first torque applies a first force to the threaded slide that is between approximately 0 to 249 pounds, wherein the second torque applies a second force to the threaded slide that is between approximately 249 to 4359 pounds, wherein the threaded slide moves a first distance from the brake clearance position to the brake adjacent position that is between approximately 3.0 to 0.17 inches, and wherein the threaded slide moves a second distance from the brake adjacent position to the brake applied position that is between approximately 0.17 to 0 inches.

54. The system of claim 53, wherein the first force is approximately 249 pounds, wherein the second force is approximately 2157 pounds, wherein the first distance is approximately 2.5 inches, and wherein the second distance is approximately 0.17 inches.

55. The system of claim 53, wherein the first force is approximately 249 pounds, wherein the second force is approximately 4359 pounds, wherein the first distance is approximately 3.0 inches, and wherein the second distance is approximately 0.17 inches.
